(19) United States
(12) Patent Application Publication
(10) Pub. No.: US 2017/0004803 A1
(43) Pub. Date: Jan. 5, 2017

(54) MOBILE DEVICE WITH MULTIPLE USER-CONFIGURABLE DISPLAYS

(71) Applicant: International Business Machines Corporation, Armonk, NY (US)

(72) Inventors: James E. Bostick, Cedar Park, TX (US); John M. Ganci, JR., Cary, NC (US); Sarbajit K. Rakshit, Kolkata (IN)

(21) Appl. No.: 14/789,038

(22) Filed: Jul. 1, 2015

(51) Int. Cl. G09G 5/00; G06F 3/14; G06F 1/16; G09G 5/14

(52) U.S. Cl. CPC G09G 5/005; G09G 5/14; G06F 3/1446; G06F 1/1654; G06F 1/1649; G09G 2360/04

(57) ABSTRACT

Managing multiple displays is provided. Displays of a mobile device are configured based, at least in part, on a display policy. Each display is removably attached to a housing of the mobile device. An overlapped portion of a first display of the plurality of displays is identified based, at least in part, on a position of a second display of the plurality of displays. Content is displayed on a viewable portion of the first display and a viewable portion of the second display based, at least in part, on one or more restrictions of the display policy. The viewable portion of the first display is based, at least in part, on the overlapped portion of the first display.

### TECHNICAL FIELD

The present invention relates generally to the field of handheld mobile devices and, more particularly, to mobile devices with multiple user-configurable displays.

### BACKGROUND OF THE INVENTION

As electronic device technology progresses, an increasing number of operations can be performed with handheld mobile devices. Mobile devices are used for entertainment, work, and personal tasks, and users demand increasing levels of functionality, simplicity, and efficiency in mobile devices.

### SUMMARY

According to one embodiment of the present invention, a method for managing multiple displays is provided. The method includes: configuring, by one or more processors, a plurality of displays of a mobile device based, at least in part, on a display policy, wherein each of the plurality of displays is removably attached to a housing of the mobile device; identifying, by one or more processors, an overlapped portion of a first display of the plurality of displays based, at least in part, on a position of a second display of the plurality of displays; displaying, by one or more processors, content on a viewable portion of the first display and a viewable portion of the second display based, at least in part, on one or more restrictions of the display policy, wherein the viewable portion of the first display is based, at least in part, on the overlapped portion of the first display.

According to another embodiment of the present invention, a computer program product for managing multiple displays is provided. The computer program product comprises a computer readable storage medium and program instructions stored on the computer readable storage medium. The program instructions include: program instructions to configure a plurality of displays of a mobile device based, at least in part, on a display policy, wherein each of the plurality of displays is removably attached to a housing of the mobile device; program instructions to identify an overlapped portion of a first display of the plurality of displays based, at least in part, on a position of a second display of the plurality of displays; program instructions to display content on a viewable portion of the first display and a viewable portion of the second display based, at least in part, on one or more restrictions of the display policy, wherein the viewable portion of the first display is based, at least in part, on the overlapped portion of the first display.

According to another embodiment of the present invention, a computer system for managing multiple displays is provided. The computer system includes one or more computer processors, one or more computer readable storage media, and program instructions stored on the computer readable storage media for execution by at least one of the one or more processors. The program instructions include: program instructions to configure a plurality of displays of a mobile device based, at least in part, on a display policy, wherein each of the plurality of displays is removably attached to a housing of the mobile device; program instructions to identify an overlapped portion of a first display of the plurality of displays based, at least in part, on a position of a second display of the plurality of displays; program instructions to display content on a viewable portion of the first display and a viewable portion of the second display based, at least in part, on one or more restrictions of the display policy, wherein the viewable portion of the first display is based, at least in part, on the overlapped portion of the first display.

### BRIEF DESCRIPTION OF THE DRAWINGS

FIG. 1 is a functional block diagram of a computing environment, in accordance with an embodiment of the present disclosure;

FIG. 2A is a front plan view of a mobile device with multiple user-configurable displays, in accordance with an embodiment of the present disclosure;

FIG. 2B is a back plan view of the mobile device of FIG. 2A, in accordance with an embodiment of the present disclosure;

FIG. 3 is an axonometric view of a mobile device with multiple user-configurable displays, in accordance with an embodiment of the present disclosure;

FIG. 4 is an axonometric view depicting a mobile device with multiple user-configurable displays, in accordance with an embodiment of the present disclosure;

FIG. 5 is a top plan view of a mobile device with multiple user-configurable displays, in accordance with an embodiment of the present disclosure;

FIG. 6 is a flowchart depicting operations for managing multiple user-configurable displays, in accordance with an embodiment of the present invention; and

FIG. 7 is a block diagram of components of a computing device executing operations for managing multiple user-configurable displays of a mobile device, in accordance with an embodiment of the present disclosure.

### DETAILED DESCRIPTION

Embodiments of the present invention recognize that the use of mobile devices with multiple displays is increasing. Some mobile devices have multiple flexible displays that bend or fold, allowing a user to alter and choose which displays are viewable at one time.

Embodiments of the present invention provide a mobile device that has multiple user-configurable displays. In some embodiments, the displays can be configured independently. In some embodiments, the displays can be rotated, pivoted, or otherwise repositioned relative to one another. Embodiments provide for detecting a newly-inserted display and transferring content from one or more displays to the newly-inserted display. Embodiments provide for identifying an overlap of two or more displays. Embodiments provide for displaying content across two or more displays.

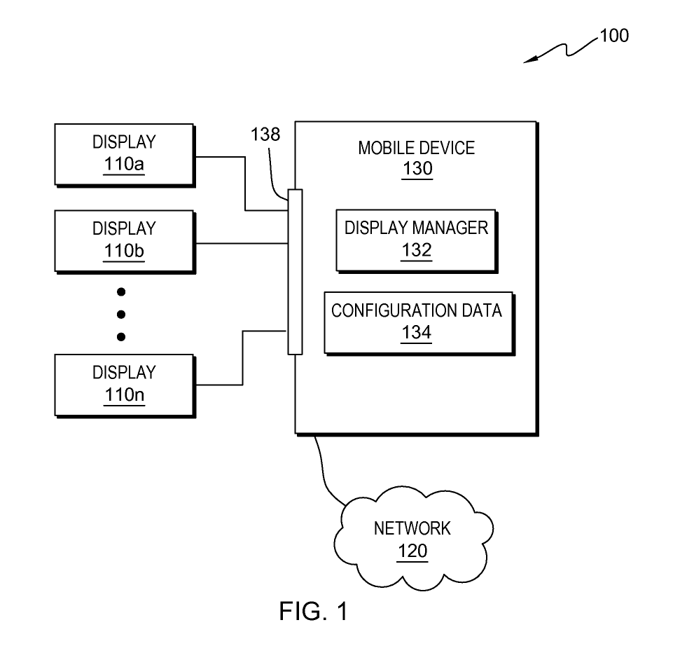

Embodiments of the present invention will now be described in detail with reference to the Figures. FIG. 1 is a functional block diagram illustrating a computing environment, in accordance with an embodiment of the present invention. For example, FIG. 1 is a functional block diagram illustrating computing environment 100. Computing environment 100 includes displays 110a-n (collectively referred to as displays 110) and mobile device 130 connected via interface 138. Mobile device 130 is connected to network 120. Mobile device 130 includes display manager 132, configuration data 134, and interface 138.

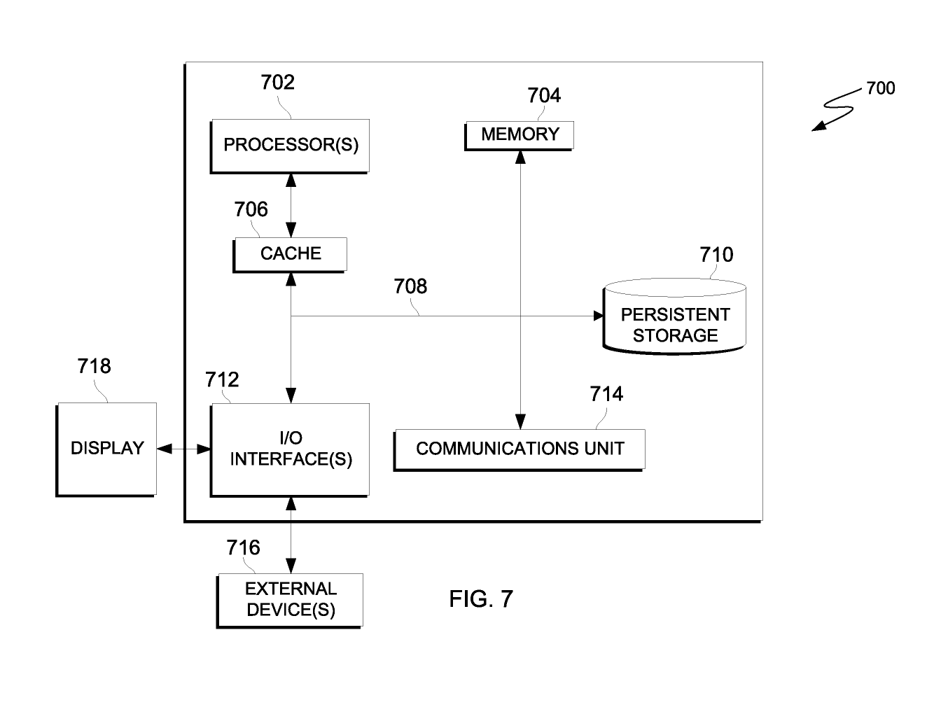

In one embodiment, mobile device 130 is a mobile computing device. For example, mobile device 130 may be a smartphone, tablet, or mobile digital media player. In various embodiments, mobile device 130 is a computing device that can be a standalone device, a wearable computing device, a server, a laptop computer, a tablet computer, a netbook computer, a personal computer (PC), or a desktop computer. In another embodiment, mobile device 130 represents a computing system utilizing clustered computers and components to act as a single pool of seamless resources. In general, mobile device 130 can be any computing device or a combination of devices with access to and/or capable of executing display manager 132 and configuration data 134. In some embodiments, mobile device 130 includes hardware that can capture imagery (e.g., a camera or photoreceptor). For example, the camera can detect images of a user of mobile device 130 which, in combination with gaze-point detection logic, can detect a gaze point of a user of mobile device 130. Mobile device 130 may include internal and external hardware components, as depicted and described in further detail with respect to FIG. 7.

In this embodiment, display manager 132 and configuration data 134 are stored on mobile device 130. In other embodiments, one or both of display manager 132 and configuration data 134 may reside on another computing device, provided that each can access and is accessible by each other, and provided that display manager 132 can access interface 138. In yet other embodiments, one or both of display manager 132 and configuration data 134 may be stored externally and accessed through a communication network, such as network 120. Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications to and from mobile device 130, in accordance with a desired embodiment of the present invention. In some embodiments, displays 110 are connected to mobile device 130 via network 120. In this case, interface 138 represents a portion of network 120. For example, interface 138 may represent any combination of wired, wireless, fiber optic, or any other connection known in the art and any combination of connections and protocols that will support communications between mobile device 130 and displays 110. In other embodiment, interface 138 is a hardware interface by which displays 110 communicate with mobile device 130.

Display manager 132 operates to manage multiple user-configurable displays. For example, display manager 132 operates to manage displays 110. In various embodiments, display manager 132 controls the display of content on each of displays 110, configures settings of displays 110, detects an overlap of two or more displays 110, manages the transfer of information from a first display of displays 110 to a second display of displays 110, or any combination thereof. In one embodiment, display manager 132 configures one or more settings for one or more displays 110 of the user device. In various embodiments, configurable settings of displays 110 include one or more of: power management, security options, display resolution, display defaults, application permissions, and image viewing rules. For example, a user of mobile device 130 defines a security setting that prohibits a first display of displays 110 from displaying content from designated applications, such as high security applications or financial applications. In another example, display manager 132 transfers the content displayed on a first display from the first display to a second display in response to a user interaction or in response to a disconnect signal indicating that the first display is being unmounted or ejected.

Configuration data 134 is a data repository that may be written to and read by display manager 132. Display policy data, display specification data, and other operational data may be stored to configuration data 134. In some embodiments, configuration data 134 may be written to and read by programs and entities outside of computing environment 100 in order to populate the repository. In one embodiment, display manager 132 displays content across multiple displays, thereby effectively enlarging the viewable area of the content. For example, display manager 132 may display a first portion of an image on a first display and a second portion of the image on a second display. In various embodiments, display manager 132 extends content across multiple displays in response to a user interaction, in response to detecting a change in position of one or more of displays 110, or a combination thereof. In one embodiment, the display policy may prevent content of a particular display from extending to other displays. In one embodiment, the display policy may map particular applications to particular displays (e.g., based on unique identifiers of the displays or based on the relative positions of the displays).

Mobile device 130 includes a user interface (UI) that operates to provide a UI to a user of mobile device 130. The UI of mobile device 130 further operates to receive user input from a user via the provided user interface, thereby enabling the user to interact with mobile device 130. In one embodiment, the UI provides a user interface that enables a user of mobile device 130 to interact with display manager 132. In another embodiment, the UI provides a user interface that enables a user of mobile device 130 to interact with configuration data 134 (e.g., directly, or indirectly via display manager 132) in order to provide some or all of the data stored to configuration data 134. In various examples, the user interacts with display manager 132 in order to configure the user-configured settings. In one embodiment, the UI of mobile device 130 is stored on mobile device 130. In other embodiments, the UI is stored on another computing device, provided that the UI can access and is accessible by at least display manager 132.

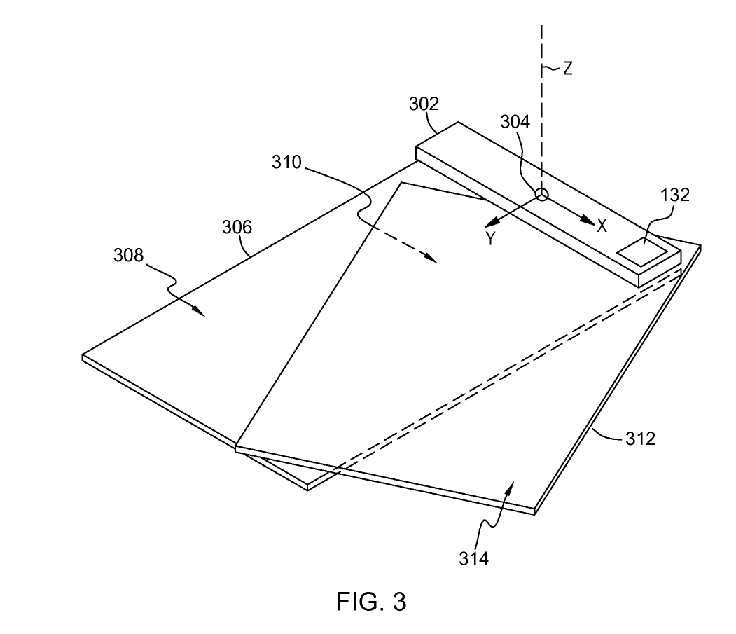

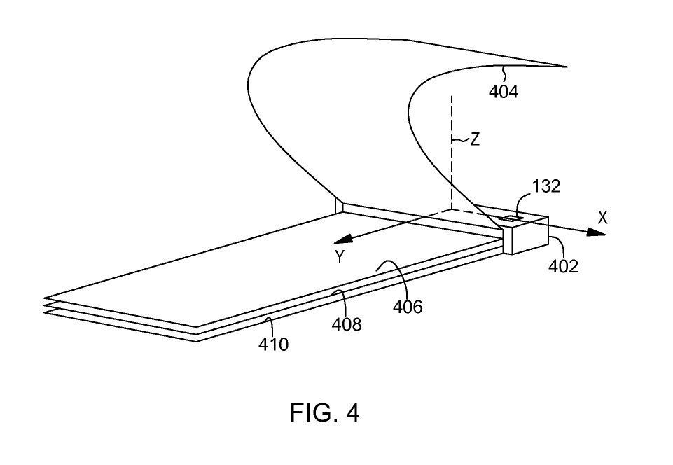

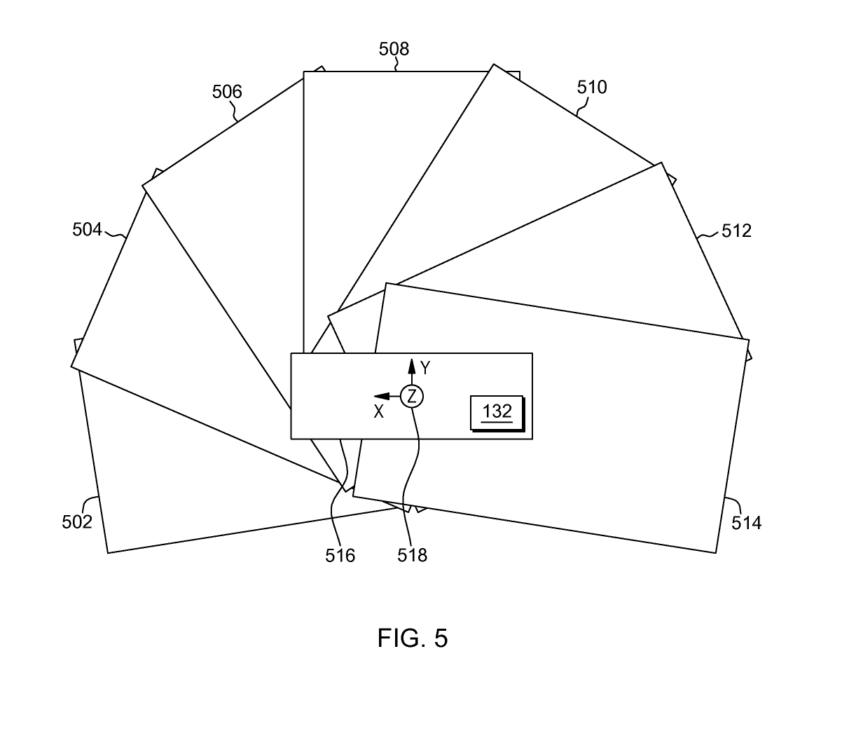

Displays 110 include one or more displays. Each of displays 110 is a flexible or rigid display utilizing technologies such as, for example, liquid-crystal display (LCD), e-paper, light emitting diode (LED), organic LED (OLED), active matrix OLED (AMOLED), or any other display technology or combination of displays technologies. Each of displays 110 can display content received from mobile device 130 via interface 138. In one embodiment, displays 110 are removably attachable to a housing of mobile device 130. In some embodiments, displays pivotally attach to the housing (e.g., FIG. 3 and FIG. 5). In other embodiments, displays 110 rotatably or hingedly attach to the housing (e.g., FIG. 4). In one embodiment, at least one of displays 110 is affixed to mobile device 130 or integrated within the housing of mobile device 130. In this case, additional displays of displays 110 are removably attachable to mobile device 130. In another embodiment, one or more of displays 110 communicate with mobile device 130 wirelessly. Each of displays 110 has a unique identifier (i.e., unique relative to at least each other of displays 110).

In some embodiments, displays 110 attach to a housing of mobile device 130 and are quadrilateral in shape with four edges: a top, bottom, left, and right. In this case, a display attaches to the housing at the bottom edge. The top edge is opposite the bottom edge. The left edge is to the left of a center point of the bottom edge (i.e., in the negative X-axis direction) and extends into the positive Y-axis direction. The right edge is to the right of a center point of the bottom edge (i.e., in the positive X-axis direction) and extends into the positive Y-axis direction. In some embodiments, the bottom edge is parallel to the top edge. In some embodiments, at least one of displays 110 is a shape other than a quadrilateral.

In one embodiment, at least one of displays 110 include one or more sensors that are positioned adjacent to or embedded within the display (e.g., a bezel of the display, the front surface, or the back surface). For ease of discussion, a sensor is said to be “on” a surface, meaning that the sensor is positioned to detect sensory data from the perspective of that surface. For example, an array of infrared sensors embedded within (i.e., “on”) a front surface of a display can detect the presence and position of an object adjacent to the front surface. In various embodiments, one or more sensors employ sensing technologies such as radar, optical sensing, capacitive sensing, proximity sensing, CMOS image sensing, or any combination thereof. The one or more sensors detect, sense, and/or measure one or more conditions such as: the presence, lack, or amount of light; a physical touch (e.g., a touch of a finger of a user); a proximal motion (e.g., an air gesture of a hand of a user); a presence or a proximity of a second object (e.g., a user, a second one of displays 110). In some embodiments, one or more sensors are disposed on mobile device 130, are disposed within mobile device 130, are affixed to mobile device 130, or are communicatively connected with mobile device 130.

In one embodiment, the sensors of a display of displays 110 operate to detect the proximity of another display of displays 110. Display manager 132 determines, based on the detected proximity, whether the displays at least partially overlap one another. Display manager 132 determines that a first display and a second display overlap if: the first display and the second display are adjacent and if a front surface of at least one of the first display and the second display is at least partially obscured by the other display. An example of overlapping displays is depicted in FIG. 3, FIG. 4, and FIG. 5. Display manager 132 restricts data from being displayed or presented on any overlapped portion of a display of displays 110.

In one embodiment, each of displays 110 has a unique configuration (e.g., unique relative to each other of displays 110). In another embodiment, the configuration of two or more displays 110 may be identical. In one embodiment, at least one of displays 110 is a touchscreen. In one embodiment, at least one of displays 110 is a touchscreen that includes at least one proximity sensor. In some embodiments, one or more displays 110 include a processor. In other embodiments, one or more displays 110 share computing resources with other displays 110 or with mobile device 130. In some embodiments, one or more displays 110 are connected to a power source specific to the display. In other embodiments, one or more displays 110 are connected to a power source common to other displays 110 or to mobile device 130.

Displays 110 includes an arbitrary number of displays. For convenience of explanation, displays 110 is assumed to include two or more displays, but it should be understood that features of the present invention may also apply to the situation in which displays 110 represents one or more displays. Generally, displays 110 refers to those displays communicatively connected to display manager 132. One or more additional displays may be added to displays 110 by communicatively connecting the one or more additional displays to display manager 132. One or more displays may be removed from displays 110 by communicatively disconnecting the one or more displays from display manager 132. In some embodiments, database 134 retains configuration settings associated with the unique identifier of a removed display.

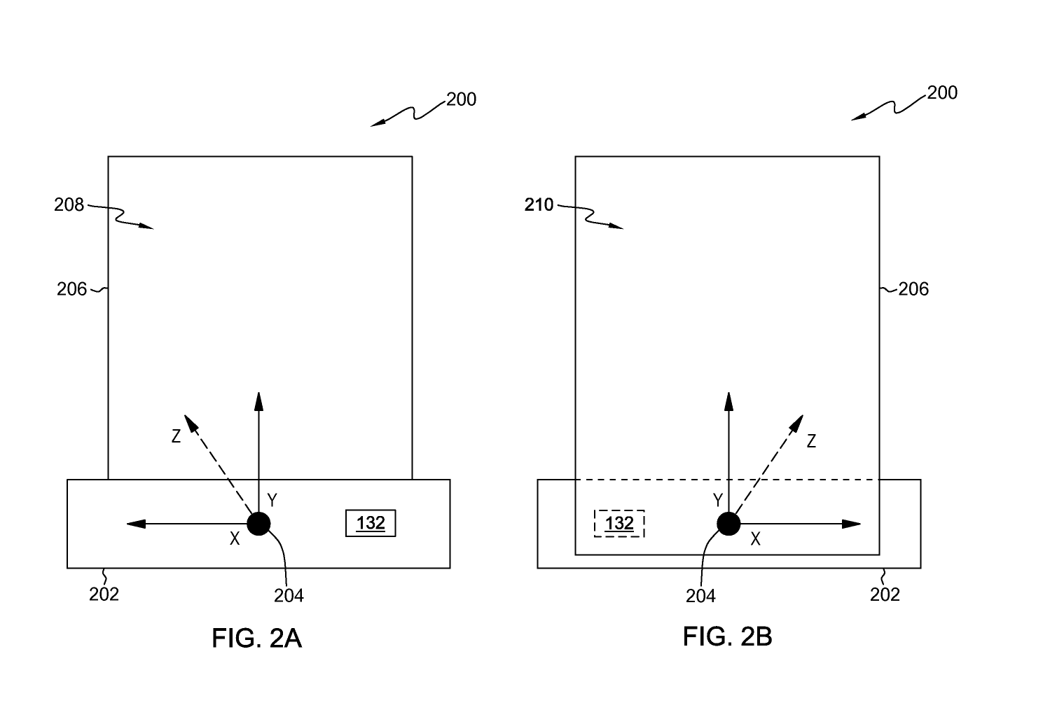

FIG. 2A is a front plan view of a mobile device with multiple user-configurable displays, in accordance with an embodiment of the present disclosure. FIG. 2B is a rear plan view of a mobile device with multiple user-configurable displays, in accordance with an embodiment of the present disclosure.

As depicted in FIGS. 2A-2B, mobile device 200 lies in three axes: an X-axis, a Y-axis, and a Z-axis. All three axes are shown superimposed over pivot point 204, which is a point at which display 206 attaches to housing 202. The Z-axis is perpendicular to a plane formed by the X- and Y-axes. Housing 202 lies within the X-Y plane and intersects the Z-axis. Display 206 lies within the X-Y plane and intersects the Z-axis at a point “below” housing 202. Thus, housing 202 can be said to be “above” display 206. In other implementations, the orientation of housing 202 and display 206 in the Z-axis may be reversed relative to one another such that housing 202 is below display 206. In embodiments in which display 206 is a flexible display device, a portion of display 206 may be flexed or bent in the direction of the Z-axis such that all or part of display 206 no longer lies in the X-Y plane. A display that is below no other displays can be said to be the “top-most” display.

Display 206 pivotally attaches to housing 202 at pivot point 204, such that display 206 can pivot around the z-axis running through pivot point 204. Pivot point 204 may be located centrally or otherwise relative to the edges of housing 202. Mobile device 200 may include hardware or software components disposed within housing 202, including display manager 132. In one embodiment, display manager 132 resides on a storage device disposed within housing 202. The storage device may also include configuration data 134. In one embodiment, pivot point 204 is a mechanical structure that positions one or more displays. In another embodiment, pivot point 204 includes interface 138, via which display manager 132 communicates with one or more displays.

Display 206 is a display of displays 110. In one embodiment, display 206 is integrated with housing 202. In this case, housing 202 may enclose at least a portion of display 206. For example, display 206 may be fixed relative to housing 202, to which additional displays 110 may be removably attached.

Display 206 includes front surface 208 and rear surface 210. Front surface 208 is capable of displaying or presenting data. In other embodiments, rear surface 210 is also capable of displaying or presenting data. The techniques described herein can be applied to implementations in which either or both of front surface 208 and rear surface 210 display or present data. However, in the interest of clarity and convenience of description, embodiments of the present invention are described with reference to an implementation in which the surface capable of displaying or presenting data to a user is referred to as front surface 208. In the implementation depicted in FIGS. 2A-2B, front surface 208 faces a portion of housing 202, which is above display 206. Thus, in the depicted implementation, front surface 208 is above back surface 210.

FIG. 3 is an axonometric view of a mobile device with multiple user-configurable displays, in accordance with an embodiment of the present disclosure.

Housing 302 is an example of a housing of mobile device 100, as is housing 202 of FIG. 2. Display 312 and display 306 are examples of displays 110. As depicted in FIG. 3, display 312 and display 306 are removably attached to housing 302 at pivot point 304. Housing 302 includes display manager 132. Housing 302 positions displays 306 and 312. In one embodiment, pivot point 304 is a mechanical structure that positions one or more displays. In another embodiment, pivot point 304 includes interface 138, via which display manager 132 communicates with one or more displays.

In the embodiment depicted in FIG. 3, display 306 is rotated zero degrees relative to housing 302 and display 312 is rotated several degrees relative to display 306. Display 306 and display 312 each have a front surface, as discussed previously. Viewable portion 308 is a portion of the front surface of display 306 that is viewable to a user of the mobile device depicted in FIG. 3. As depicted, display 312 partially overlaps display 306. Obscured portion 310 of the front surface of display 306 is obscured, and is therefore not viewable, by the portion of display 312 that overlaps obscured portion 310.

Similarly, a portion of front surface 314 of display 312 is overlapped, and is therefore obscured, by housing 302. In one embodiment, display manager 132 detects that a portion of display 312 overlaps a portion of display 306 based on one or more sensors embedded within one or both of display 312 and display 306. In another embodiment, display manager 132 detects that a portion of display 312 overlaps a portion of display 306 based on an angle of rotation and predetermined dimensions of each display.

FIG. 4 is an axonometric view depicting a mobile device with multiple user-configurable displays, in accordance with an embodiment of the present disclosure.

Housing 402 is an example of a housing of mobile device 100. Display 404, display 406, display 408, and display 410 are examples of displays 110. As depicted in FIG. 4, each display of displays 404, 406, 408, and 410 is removably attached to housing 402 along an edge of the display that is parallel to the X-axis, and housing 402 thereby positions each display. Housing 402 includes display manager 132. In one embodiment, housing 402 includes a mechanical structure that positions one or more displays. In another embodiment, housing 402 includes interface 138, via which display manager 132 communicates with one or more displays.

As depicted in FIG. 4, displays 110 may include one or more flexible displays. Display 404 is flexed in the Z-Axis and Y-Axis to change a degree of rotation of display 404 relative to other displays. In this embodiment, a user may bend a display (e.g., display 404) to reveal another display (e.g., display 406). As depicted, at least a portion of a rear surface of display 404 is visible to a user of the mobile device of FIG. 4. Further, at least a portion of a front surface of display 406 is visible to the user. However, display 406 overlaps substantially all of a front surface of display 408, which overlaps substantially all of a front surface of display 410. The user may fold back other displays to reveal surfaces that are obscured in the configuration depicted in FIG. 4. For example, the user may bend display 406 to reveal a front surface of display 408, which may also cause the front surface of display 406 and the back surface of display 404 to overlap.

FIG. 5 is a top plan view of a mobile device with multiple user-configurable displays, in accordance with an embodiment of the present disclosure.

Housing 516 is an example of a housing of mobile device 100. Displays 502, 504, 506, 508, 510, 512, and 514 are examples of displays 110. As depicted in FIG. 5, each of displays 502, 504, 506, 508, 510, 512, and 514 is pivotally attached to housing 516 at pivot point 518, and housing 502 thereby positions each display. FIG. 5 depicts a configuration with multiple displays and multiple overlapping regions.

Display 510 represents a display that has been inserted into pivot point 518 above display 508 and below display 512. Display 510, once inserted, obscures a portion of a front surface of display 508. Further, display 512 obscures a portion of a front surface of display 510. Similarly, a display may be removed from pivot point 518, which may reduce the amount by which one or more other displays are obscured. For example, display 506 obscures a portion of a front surface of display 504 and a portion of a front surface of display 502. If removed, display 506 would no longer obscure those portions of display 504 and display 502. Some or all of those portions may become visible, if not obscured by another display or by housing 516.

In the implementation depicted in FIG. 5, display 508 is rotated zero degrees relative to pivot point 518. In one embodiment, a user positions displays 502, 504, 506, 510, 512, and 514 by rotating the displays to the positions depicted in FIG. 5. The displays can pivot around pivot point 518 in a clockwise or counterclockwise direction. In one embodiment, a user removes a first display from a first position, and inserts a second display into the first position. In one embodiment, pivot point 518 is a mechanical structure that positions one or more displays. In another embodiment, pivot point 518 includes interface 138, via which display manager 132 communicates with one or more displays.

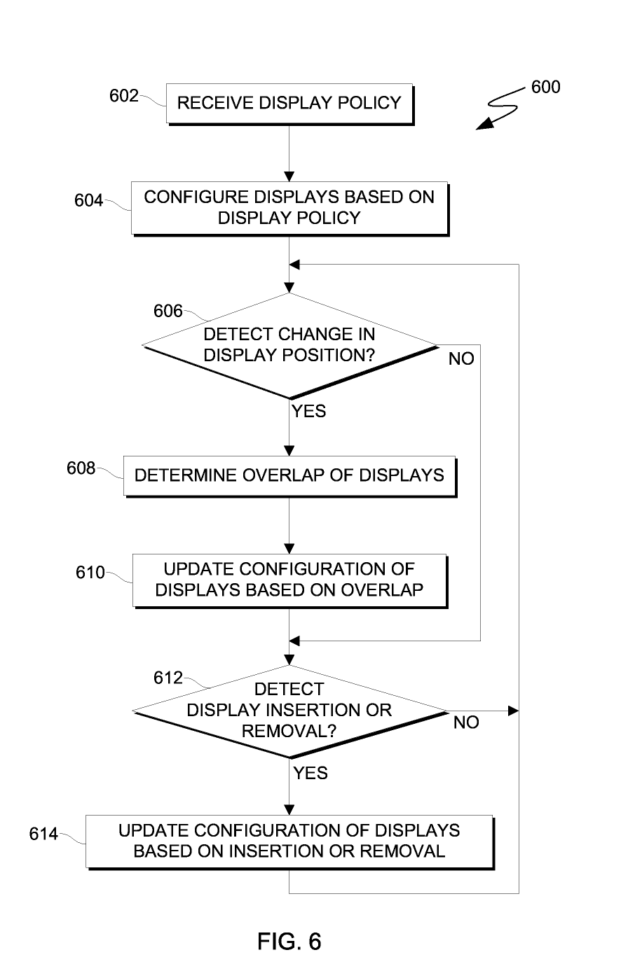

FIG. 6 is a flowchart depicting operations for managing multiple user-configurable displays, in accordance with an embodiment of the present invention.

In operation 602, display manager 132 receives a display policy. In one embodiment, the display policy includes a security policy, user preferences, or both. The display policy specifies what content may be displayed on each display of displays 110. In one embodiment, display manager 132 receives the display policy from configuration data 134. In another embodiment, display manager 132 receives the display policy as user input.

In operation 604, display manager 132 configures one or more displays based on the display policy. Display manager 132 configures displays of display 110. For example, based on the display policy, display manager 132 may restrict a display from presenting particular content, activate or deactivate portions of a display, or both.

In one embodiment, the display policy includes one or more restrictions. A restriction may specify, for example, a type of content, a file format, a data source, a power profile, or a display preference. A restriction may be specific to a particular display (e.g., based on a unique identifier of the display) or a position of a display relative to one or more other displays. For example, the display policy may include a restriction that prohibits video content from playing on any display other than the top-most display. In another example, the display policy may include one or more restrictions that restrict a data source, such as web content transmitted over secure sockets layer (SSL), to a particular display. A power profile includes power management settings. For example, a power management setting specifies switching off power to a display that is bent. In this case, display manager 132 detects that a display is bent and, based on the power management setting, switches off power to the display. A display preference includes settings such as brightness and contrast. A display preference may also include color preferences, a background or wallpaper image, a theme or application skin, or other preferences.

In one embodiment, the display policy includes display specification data, which specifies specifications such as physical dimensions and current resolution for each of displays 110. Display manager 132 identifies portions, if any, that are overlapped for each of displays 110. In one embodiment, display manager 132 identifies an overlapped portion of a display based on the physical dimensions and relative positions of each of displays 110. In another embodiment, display manager 132 identifies an overlapped portion of a display based on data from one or more sensors of the mobile device (e.g., one or more sensors of displays 110). Display manager 132 deactivates, de-illuminates, or otherwise obscures pixels within each overlapped portion of each display. An overlapped portion of a display is one that is obscured by another display or by a housing of the mobile device.

In decision 606, display manager 132 determines whether a change in display position is detected. In one embodiment, display manager 132 detects a change in position of a display based on data from a pivot point of the mobile device (e.g., pivot point 204, pivot point 304, or pivot point 518). In another embodiment, display manager 132 detects a change position of a display based on data from one or more sensors of the mobile device (e.g., one or more sensors of displays 110). If display manager 132 determines that a change in display position is detected (decision 606, YES branch), then display manager 132 determines an overlap of one or more displays (operation 608). If display manager 132 determines that a change in display position is not detected (decision 606, NO branch), then display manager 132 determines whether a display insertion or removal is detected (determination 612).

In operation 608, display manager 132 determines an overlap of one or more displays. Display manager 132 determines an overlap of the displays by identifying portions, if any, that are overlapped for each of the one or more displays. Display manager 132 identifies overlapping portions of the one or more displays via techniques described previously. In one embodiment, display manager 132 identifies overlapping portions for each display of displays 110. In another embodiment, display manager 132 identifies overlapping portions for the display that moved in position and, in yet another embodiment, another display adjacent to and below the display that moved in position.

In operation 610, display manager 132 updates the configuration of the one or more displays based on the overlap. Display manager 132 updating the configuration includes activating any portions no longer obscured for the one or more displays and deactivating any portions now obscured (due to the change in display position) for the one or more displays.

In one example, display 110a is adjacent to and above display 110b. In this example, display 110a is removably affixed to a pivot point at thirty degrees of rotation and display 110b is removably affixed to a pivot point at sixty degrees of rotation. Display 110a obscures (i.e., overlaps) a portion of a front surface of display 110b. The obscured portion of display 110b is deactivated. Display manager 132 determines that display 110a has rotated fifteen degrees in a clockwise direction based on data received from the pivot point (or, e.g., from one or more sensors of displays 110a or 110b). Due to the rotation of display 110a, an overlapped portion of the front surface of display 110b reduces in size. Display manager 132 determines the overlap of displays 110a and 110b and, in response, activates any portions of display 110b that are no longer obscured and deactivates any portions of display 110b that are obscured.

In some embodiments, display manager 132 updating the configuration may include stopping, pausing, or otherwise interacting with media (e.g., audio, video) playing (e.g., local file playback or streaming) on a display that becomes obscured above a predetermined threshold. For example, display manager 132 determines that a first display has been moved in position such that it obscures substantially all of a front surface of a second display. In response, display manager 132 stops or pauses playback of media on the second display. In another example, display manager 132 determines that the moved display obscures a particular percentage of another display. In response to determining that the particular percentage exceeds a predetermined threshold, display manager 132 stops or pauses media being played on the obscured display. In another embodiment, display manager 132 deactivates the pixels of the obscured portion of the display without interacting with the playback of the media. In some embodiments, display manager 132 determines whether to allow media playback to continue based on user input.

In decision 612, display manager 132 determines whether a display insertion or removal is detected. Display manager 132 is communicatively connected to each of displays 110. In one embodiment, display manager 132 determines that a display is removed in response to the connection being terminated by the display or by display manager 132. In another embodiment, display manager 132 determines that a display is inserted in response to establishing a new connection with the inserted display. If display manager 132 determines that a display insertion or removal is detected (decision 612, YES branch), then display manager 132 updates the configuration of displays based on the insertion or removal of a display (operation 614). If display manager 132 determines that a display insertion or removal is not detected (decision 612, NO branch), then display manager 132 returns to determine whether a change in display position is detected (decision 606).

In operation 614, display manager 132 updates the configuration of displays based on the insertion or removal of a display. In one embodiment, display manager 132 updates a configuration for each of displays 110 to ensure compliance with the restrictions of the display policy. In one example, the display policy restricts presenting confidential data (e.g., financial data, personal information, or other information designated as confidential) on the top-most display. In this example, a first display is adjacent to and above a second display, and the first display is the top-most display. In response to detecting that the first display is removed, display manager 132 determines that the second display has become the top-most display and display manager 132 restricts the second display from presenting financial data.

In some embodiments, display manager 132 may transfer content being presented via a display to another display. For example, display manager 132 determines that a display is removed and, in response, display manager 132 transfers all content that was presented via the removed display to another display to which display manager 132 is still connected. In another example, display manager 132 determines that an inserted display obscures substantially all of another display and, in response, display manager 132 transfers all content being presented via the other display to the inserted display. In other embodiments, display manager 132 transfers from one display to another display in response to user input.

FIG. 7 is a block diagram of components of a computing device, generally designated 700, in accordance with an embodiment of the present invention. In one embodiment, computing system 700 is representative of mobile device 130 within computing environment 100, in which case mobile device 130 includes display manager 132 and configuration data 134.

It should be appreciated that FIG. 7 provides only an illustration of one implementation and does not imply any limitations with regard to the environments in which different embodiments may be implemented. Many modifications to the depicted environment may be made.

Computing system 700 includes processor(s) 702, cache 706, memory 704, persistent storage 710, input/output (I/O) interface(s) 712, communications unit 714, and communications fabric 708. Communications fabric 708 provides communications between cache 706, memory 704, persistent storage 710, communications unit 714, and input/output (I/O) interface(s) 712. Communications fabric 708 can be implemented with any architecture designed for passing data and/or control information between processors (such as microprocessors, communications and network processors, etc.), system memory, peripheral devices, and any other hardware components within a system. For example, communications fabric 708 can be implemented with one or more buses or a crossbar switch.

Memory 704 and persistent storage 710 are computer readable storage media. In this embodiment, memory 704 includes random access memory (RAM). In general, memory 704 can include any suitable volatile or non-volatile computer readable storage media. Cache 706 is a fast memory that enhances the performance of processor(s) 702 by holding recently accessed data, and data near recently accessed data, from memory 704.

Program instructions and data used to practice embodiments of the present invention may be stored in persistent storage 710 and in memory 704 for execution by one or more of the respective processor(s) 702 via cache 706. In an embodiment, persistent storage 710 includes a magnetic hard disk drive. Alternatively, or in addition to a magnetic hard disk drive, persistent storage 710 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 710 may also be removable. For example, a removable hard drive may be used for persistent storage 710. Other examples include optical and magnetic disks, thumb drives, and smart cards that are inserted into a drive for transfer onto another computer readable storage medium that is also part of persistent storage 710.

Communications unit 714, in these examples, provides for communications with other data processing systems or devices. In these examples, communications unit 714 includes one or more network interface cards. Communications unit 714 may provide communications through the use of either or both physical and wireless communications links. Program instructions and data used to practice embodiments of the present invention may be downloaded to persistent storage 710 through communications unit 714.

I/O interface(s) 712 allows for input and output of data with other devices that may be connected to each computer system. For example, I/O interface(s) 712 may provide a connection to external device(s) 716 such as a keyboard, keypad, a touch screen, and/or some other suitable input device. External device(s) 716 can also include portable computer readable storage media such as, for example, thumb drives, portable optical or magnetic disks, and memory cards. Software and data used to practice embodiments of the present invention can be stored on such portable computer readable storage media and can be loaded onto persistent storage 710 via I/O interface(s) 712. I/O interface(s) 712 also connect to display 718.

Display 718 provides a mechanism to display or present data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The term(s) “Smalltalk” and the like may be subject to trademark rights in various jurisdictions throughout the world and are used here only in reference to the products or services properly denominated by the marks to the extent that such trademark rights may exist.

The term “exemplary” means of or relating to an example and should not be construed to indicate that any particular embodiment is preferred relative to any other embodiment.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for managing multiple displays, the method comprising:
configuring, by one or more processors, a plurality of displays of a mobile device based, at least in part, on a display policy, wherein each of the plurality of displays is removably attached to a housing of the mobile device;
identifying, by one or more processors, an overlapped portion of a first display of the plurality of displays based, at least in part, on a position of a second display of the plurality of displays; and
displaying, by one or more processors, content on a viewable portion of the first display and a viewable portion of the second display based, at least in part, on one or more restrictions of the display policy, wherein the viewable portion of the first display is based, at least in part, on the overlapped portion of the first display.

2. The method of claim 1, further comprising:
presenting, by one or more processors, a first content via a top-most display of the plurality of displays, wherein the top-most display is below no other displays of the plurality of displays;
presenting, by one or more processors, a second content via an adjacent display, wherein the adjacent display is below the top-most display; and
determining, by one or more processors, that the top-most display is removed from the plurality of displays, such that the adjacent display is no longer below any other display of the plurality of displays and, in response, determining, by one or more processors, that the second content is restricted from being presented via the adjacent display.

3. The method of claim 1, wherein the second display obscures the overlapped portion of the first display such that a user is prevented from viewing the overlapped portion of the first display.

4. The method of claim 1, further comprising:
detecting, by one or more processors, a change in position of the second display and, in response, identifying, by one or more processors, an overlapped portion of the first display based on the change in position of the second display.

5. The method of claim 1, further comprising:
deactivating, by one or more processors, one or more pixels within the overlapped portion of the first display in response to identifying the overlapped portion.

6. The method of claim 1, wherein the one or more restrictions of the display policy include a first restriction specifying at least one of: a content type, a file format, a data source, a power configuration, a display preference.

7. The method of claim 6, wherein the first restriction further specifies a unique identifier of a display of the plurality of displays.

8. The method of claim 1, further comprising:
detecting, by one or more processors, an insertion of a third display based, at least in part, on an initiation of a communications link between the third display and at least one of the one or more processors; and
determining, by one or more processors, that the third display obscures at least a portion of a surface of a second display and, in response, transferring at least a portion of content from the second display to the third display.

9. A computer program product for managing multiple displays, the computer program product comprising:
a computer readable storage medium and program instructions stored on the computer readable storage medium, the program instructions comprising:
program instructions to configure a plurality of displays of a mobile device based, at least in part, on a display policy, wherein each of the plurality of displays is removably attached to a housing of the mobile device;
program instructions to identify an overlapped portion of a first display of the plurality of displays based, at least in part, on a position of a second display of the plurality of displays; and
program instructions to display content on a viewable portion of the first display and a viewable portion of the second display based, at least in part, on one or more restrictions of the display policy, wherein the viewable portion of the first display is based, at least in part, on the overlapped portion of the first display.

10. The computer program product of claim 9, wherein the program instructions further comprise:
program instructions to present a first content via a top-most display of the plurality of displays, wherein the top-most display is below no other displays of the plurality of displays;
program instructions to present a second content via an adjacent display, wherein the adjacent display is below the top-most display; and
program instructions to determine that the top-most display is removed from the plurality of displays, such that the adjacent display is no longer below any other display of the plurality of displays and, in response, determine that the second content is restricted from being presented via the adjacent display.

11. The computer program product of claim 9, wherein the second display obscures the overlapped portion of the first display such that a user is prevented from viewing the overlapped portion of the first display.

12. The computer program product of claim 9, wherein the program instructions further comprise:
program instructions to detect a change in position of the second display and, in response, identify an overlapped portion of the first display based on the change in position of the second display.

13. The computer program product of claim 9, wherein the program instructions further comprise:
deactivating, by one or more processors, one or more pixels within the overlapped portion of the first display in response to identifying the overlapped portion.

14. The computer program product of claim 9, wherein the one or more restrictions of the display policy include a first restriction specifying at least one of: a content type, a file format, a data source, a power configuration, a display preference.

15. A computer system for managing multiple displays, the computer system comprising:
one or more computer processors;
one or more computer readable storage media;
program instructions stored on the computer readable storage media for execution by at least one of the one or more processors, the program instructions comprising:
program instructions to configure a plurality of displays of a mobile device based, at least in part, on a display policy, wherein each of the plurality of displays is removably attached to a housing of the mobile device;
program instructions to identify an overlapped portion of a first display of the plurality of displays based, at least in part, on a position of a second display of the plurality of displays; and
program instructions to display content on a viewable portion of the first display and a viewable portion of the second display based, at least in part, on one or more restrictions of the display policy, wherein the viewable portion of the first display is based, at least in part, on the overlapped portion of the first display.

16. The computer system of claim 15, wherein the program instructions further comprise:
program instructions to present a first content via a top-most display of the plurality of displays, wherein the top-most display is below no other displays of the plurality of displays;
program instructions to present a second content via an adjacent display, wherein the adjacent display is below the top-most display; and
program instructions to determine that the top-most display is removed from the plurality of displays, such that the adjacent display is no longer below any other display of the plurality of displays and, in response, determine that the second content is restricted from being presented via the adjacent display.

17. The computer system of claim 15, wherein the second display obscures the overlapped portion of the first display such that a user is prevented from viewing the overlapped portion of the first display.

18. The computer system of claim 15, wherein the program instructions further comprise:
program instructions to detect a change in position of the second display and, in response, identify an overlapped portion of the first display based on the change in position of the second display.

19. The computer system of claim 15, wherein the program instructions further comprise:
deactivating, by one or more processors, one or more pixels within the overlapped portion of the first display in response to identifying the overlapped portion.

20. The computer system of claim 15, wherein the one or more restrictions of the display policy include a first restriction specifying at least one of: a content type, a file format, a data source, a power configuration, a display preference.
